(19) United States
(12) Patent Application Publication
(10) Pub. No.: US 2009/0175460 A1
(43) Pub. Date: Jul. 9, 2009

(54) ARTIFICIAL MOUTH WITH ACOUSTIC TUBE OUTPUTTING PLANE WAVES

(75) Inventor: Bo Zhang, Nanjing (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 12/107,910

(22) Filed: Apr. 23, 2008

Related U.S. Application Data
(60) Provisional application No. 61/019,859, filed on Jan. 9, 2008.

(51) Int. Cl. H04R 29/00; G10K 11/00

(52) U.S. Cl. 381/58; 181/175

(57) ABSTRACT

An artificial mouth includes a front cover, a loudspeaker, and an acoustic tube. The front cover has a plurality of holes which is coplanar. The loudspeaker generates sound waves which pass through the acoustic tube, and turn into plane waves when arriving at the plurality of holes of the front cover.

### CROSS REFERENCE TO RELATED APPLICATIONS

This application claims the benefit of U.S. Provisional Application No. 61/019,859.

### BACKGROUND OF THE INVENTION

1. Field of the Invention

The invention relates to an artificial mouth for testing at least one microphone, and more particularly to an artificial mouth capable of being used for a phase matching test, sensitivity test, microphone categorization test, etc. for a plurality of microphones.

2. Description of the Related Art

An artificial mouth can be used for testing the sensitivity of a microphone. Referring to FIG. 1, a conventional artificial mouth 10 includes a loudspeaker 11, a front cover 12 affixed to the loudspeaker 11, and an acoustic tube 13 provided in the front cover 12. The front cover 12 has a hole 121. In a test, a microphone is disposed in the hole 121 of the front cover 12 to receive sound waves from the loudspeaker 11 through the acoustic tube 13. The test, however, is not efficient because only one microphone is tested by the artificial mouth 10 which is provided with only one hole 121. Further, the artificial mouth 10 can not be used for a phase matching test for a plurality of microphones due to the same reason.

### BRIEF SUMMARY OF THE INVENTION

The invention provides an artificial mouth capable of being used to test a plurality of microphones.

The invention also provides an artificial mouth capable of being used for a phase matching test, a sensitivity test, a microphone categorization test, etc. for a plurality of microphones.

The artificial mouth in accordance with an exemplary embodiment of the invention includes a front cover, a loudspeaker, and an acoustic tube. The front cover has a plurality of holes which is coplanar. The loudspeaker generates sound waves which pass through the acoustic tube, and turn into plane waves when arriving at the plurality of holes of the front cover.

In another exemplary embodiment, the acoustic tube is a round tube.

In yet another exemplary embodiment, the acoustic tube is a square tube.

In another exemplary embodiment, the artificial mouth further includes an anti-dust screen disposed between the acoustic tube and the loudspeaker.

In yet another exemplary embodiment, the acoustic tube is made of brass.

In another exemplary embodiment, the acoustic tube is made of marble.

In yet another exemplary embodiment, the acoustic tube is made of stainless steel.

The invention also provides a process for testing at least one microphone. The process in accordance with an exemplary embodiment comprises the steps of providing the above artificial mouth, locating the microphone and a standard microphone in the plurality of holes, and turning the loudspeaker to a work frequency less than a cut-off frequency of the acoustic tube.

In another exemplary embodiment, the acoustic tube is a round tube, and the cut-off frequency of the acoustic tube

$$f = \frac{1.84 c}{π D} ,$$

wherein c is a speed of the sound waves in air, and D is a diameter of the acoustic tube.

In yet another exemplary embodiment, the acoustic tube is a square tube, and the cut-off frequency of the acoustic tube

$$f = \frac{c}{2 D} ,$$

wherein c is a speed of the sound waves in air, and D is a side length of the acoustic tube.

In another exemplary embodiment, the cut-off frequency of the acoustic tube

$$f = \frac{c}{2 L} ,$$

wherein c is a speed of the sound waves in air, and L is an effective length of the acoustic tube.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a conventional artificial mouth;

FIG. 2 is a schematic diagram of an artificial mouth in accordance with a first embodiment of the invention;

FIG. 3A is a perspective diagram of an artificial mouth in accordance with a second embodiment of the invention;

FIG. 3B is a sectional view of the artificial mouth in accordance with the second embodiment of the invention;

FIG. 4A is a perspective diagram of an artificial mouth in accordance with a second embodiment of the invention; and

FIG. 4B is a sectional view of the artificial mouth in accordance with the second embodiment of the invention.

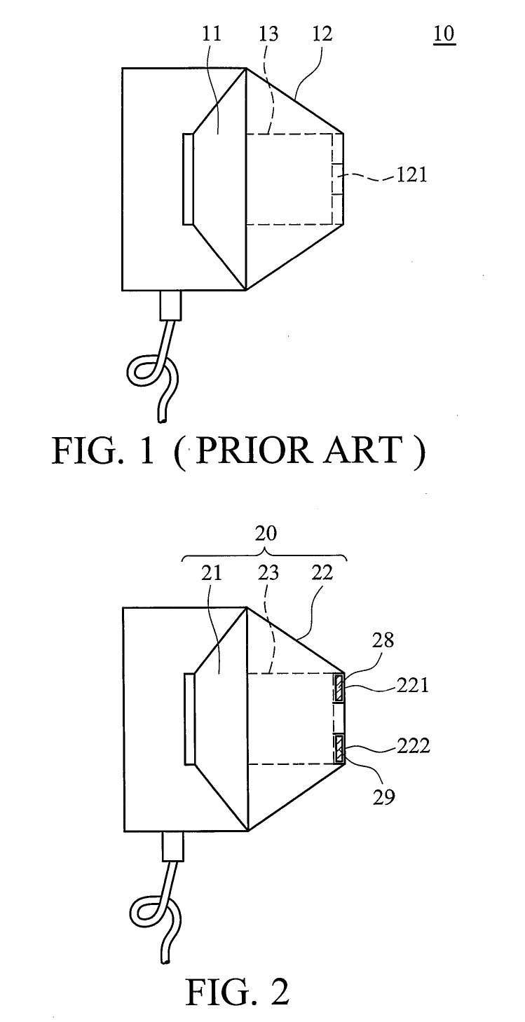

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

Referring to FIG. 2, in a first embodiment of the invention, an artificial mouth 20 comprises a loudspeaker 21, a front cover 22 affixed to the loudspeaker 21, and an acoustic tube 23 provided in the front cover 22. The front cover 22 has two holes 221 and 222 which are arranged in a plane. The acoustic tube 23 may be made of brass, marble, stainless steel, and others.

During a test, two microphones 28 and 29 are disposed in the holes 221 and 222 of the front cover 22, respectively. Sound waves generated by the loudspeaker 21 pass through the acoustic tube 23 to the microphones 28 and 29. The two microphones 28 and 29 are coplanar because the holes 221 and 222 are coplanar. Additionally, the acoustic tube 23 is implemented in such a way that the output sound waves are “plane waves”. Thus, the phase, amplitude, and frequency response obtained from the two microphones 28 and 29 are consistent, which enables the utilization of the artificial mouth 20 to be applied to a phase matching test, sensitivity test, microphone categorization test, etc.

In the first embodiment, the two microphones 28 and 29 are a standard microphone and a test microphone, respectively.

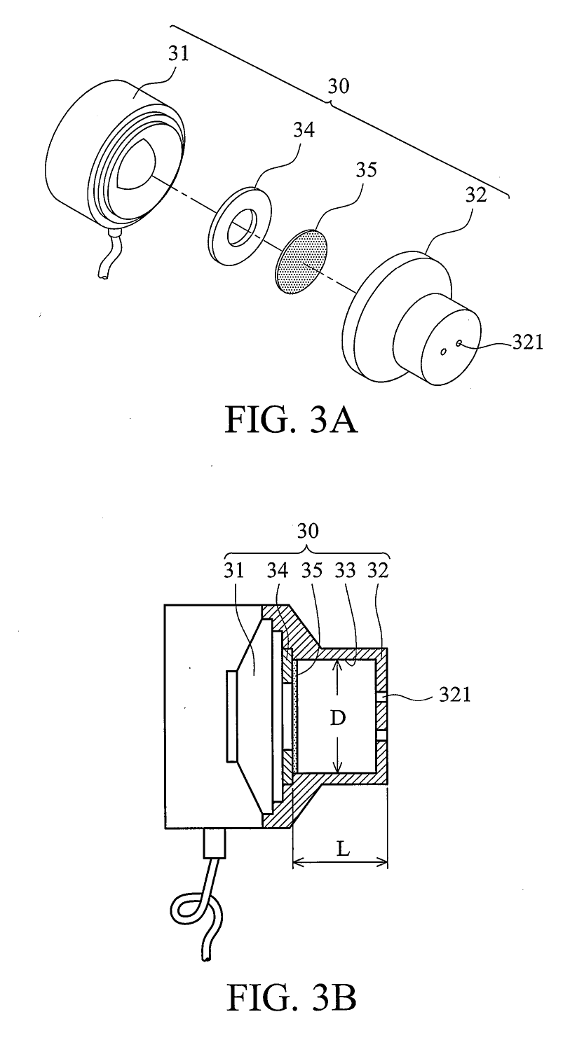

Referring to FIGS. 3A and 3B, in a second embodiment of the invention, an artificial mouth 30 comprises a loudspeaker 31, a front cover 32 affixed to the loudspeaker 31, an anti-dust screen 35 affixed to the front cover 32 by a fixing ring 34, and an acoustic tube 33 provided in the front cover 32. The front cover 32 has two holes 321 which are arranged in a plane. The anti-dust screen 35 is disposed between the acoustic tube 33 and the loudspeaker 31 and prevents the loudspeaker 31 from dust or foreign objects. The acoustic tube 33 may be made of brass, marble, stainless steel, and others.

During a test, two microphones are disposed in the holes 321 of the front cover 32, respectively. Sound waves generated by the loudspeaker 31 pass through the acoustic tube 33 to the microphones. The two microphones are coplanar because the holes 321 are coplanar. Additionally, the acoustic tube 33 is implemented in such a way that the output sound waves are “plane waves”. Thus, the phase, amplitude, and frequency response obtained from the two microphones are consistent, which enables the utilization of the artificial mouth 30 to be applied to a phase matching test, sensitivity test, microphone categorization test, etc.

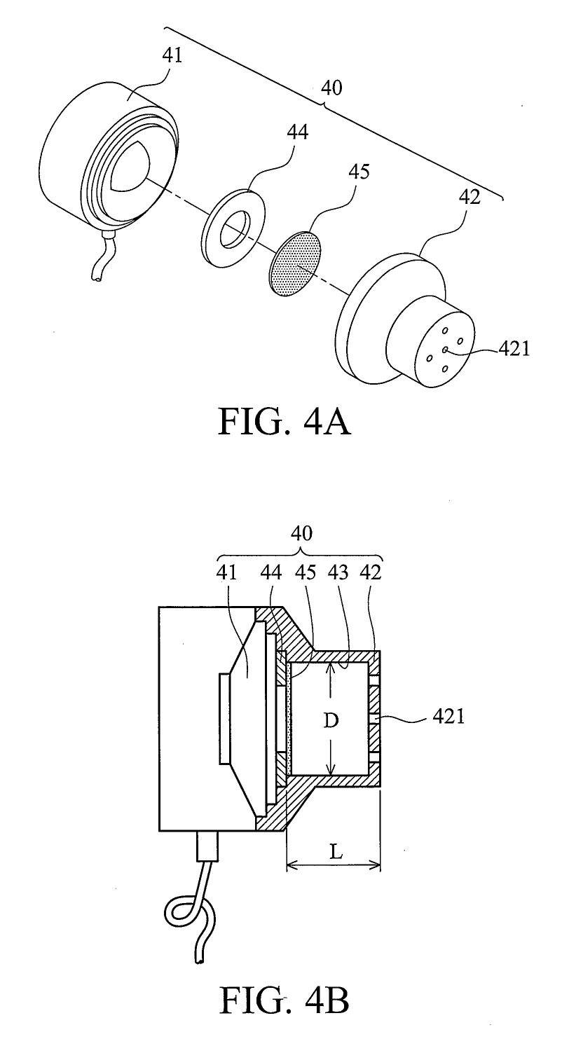

Referring to FIGS. 4A and 4B, in a third embodiment of the invention, an artificial mouth 40 comprises a loudspeaker 41, a front cover 42 affixed to the loudspeaker 41, an anti-dust screen 45 affixed to the front cover 42 by a fixing ring 44, and an acoustic tube 43 provided in the front cover 42. The front cover 42 has more than two holes 421 which are arranged in a plane. The anti-dust screen 45 is disposed between the acoustic tube 43 and the loudspeaker 41 and prevents the loudspeaker 41 from dust or foreign objects. The acoustic tube 43 may be made of brass, marble, stainless steel, and others.

During a test, a plurality of microphones is disposed in the holes 421 of the front cover 42, respectively. Sound waves generated by the loudspeaker 41 pass through the acoustic tube 43 to the microphones. The microphones are coplanar because the holes 421 are coplanar. Additionally, the acoustic tube 43 is implemented in such a way that the output sound waves are “plane waves”. Thus, the phase, amplitude, and frequency response obtained from the microphones are consistent, which enables the utilization of the artificial mouth 40 to be applied to a phase matching test, sensitivity test, microphone categorization test, etc.

The sound waves output from the acoustic tube will be plane waves if the work frequency of the loudspeaker is less than the cut-off frequency of the acoustic tube. The cut-off frequency is determined by the shape and the sizes of the acoustic tube:

For a round tube, the cut-off frequency

$${f}_{1} = \frac{1.84 c}{π D} , \qquad ( 1 )$$

wherein c is the speed of sound in the air, and
D is the inner diameter of the round tube.

For a square tube, the cut-off frequency

$${f}_{1} = \frac{c}{2 D} , \qquad ( 2 )$$

wherein c is the speed of sound in the air, and
D is the side length (or width) of the square tube.

Furthermore, to avoid the maximum and minimum sound pressure generated in the acoustic tube, the cut-off frequency f₂ is determined as follows:

$${f}_{2} = \frac{c}{2 l} , \qquad ( 3 )$$

wherein c is the speed of sound in the air, and
l is the effective length of the acoustic tube.

### PRACTICAL EXAMPLE

Referring to FIG. 3B or 4B, the acoustic tube is a round tube with an inner diameter D=0.04 m and an effective length L=0.04 m. The loudspeaker was turned to a work frequency of 4 KHz (or more). The speed of sound in the air was 343 m/s.

According to formula (1), the cut-off frequency

$${f}_{1} = \frac{1.84 \times 343}{3.14 \times 0.04} = 5025 Hz >$$

than the work frequency 4 KHz. It was therefore understood that the sound waves output from the acoustic tube are plane waves.

According to formula (3), the cut-off frequency

$${f}_{2} = \frac{343}{2 \times 0.04} = 4288 Hz > than$$

the work frequency 4 KHz. It was therefore understood that no wave peak and trough occurred in the frequency response when the frequency was less than 4 KHz.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An artificial mouth comprising:
a front cover having a plurality of holes which is coplanar;
an acoustic tube disposed in the front cover; and
a loudspeaker generating sound waves, wherein the sound waves pass through the acoustic tube, and turn into plane waves when arriving at the plurality of holes of the front cover.

2. The artificial mouth as claimed in claim 1, wherein the acoustic tube is a round tube.

3. The artificial mouth as claimed in claim 1, wherein the acoustic tube is a square tube.

4. The artificial mouth as claimed in claim 1, further comprising an anti-dust screen disposed between the acoustic tube and the loudspeaker.

5. The artificial mouth as claimed in claim 1, wherein the acoustic tube is made of brass.

6. The artificial mouth as claimed in claim 1, wherein the acoustic tube is made of marble.

7. The artificial mouth as claimed in claim 1, wherein the acoustic tube is made of stainless steel.

8. A process for testing at least one microphone, comprising:
providing an artificial mouth as claimed in claim 1;
locating the microphone and a standard microphone in the plurality of holes; and
tuning the loudspeaker to a work frequency less than a cut-off frequency of the acoustic tube.

9. The process for testing at least one microphone as claimed in claim 8,
wherein the acoustic tube is a round tube, and the cut-off frequency of the acoustic tube
$$f = \frac{1.84 c}{π D} ,$$
wherein c is a speed of the sound waves in air, and
D is a diameter of the acoustic tube.

10. The process for testing at least one microphone as claimed in claim 8,
wherein the acoustic tube is a square tube, and the cut-off frequency of the acoustic tube
$$f = \frac{c}{2 D} ,$$
wherein c is a speed of the sound waves in air, and
D is a side length of the acoustic tube.

11. The process for testing at least one microphone as claimed in claim 8,
wherein the cut-off frequency of the acoustic tube
$$f = \frac{c}{2 L} ,$$
wherein c is a speed of the sound waves in air, and
L is an effective length of the acoustic tube.
